(19) United States
(12) Patent Application Publication
(10) Pub. No.: US 2011/0185864 A1
(43) Pub. Date: Aug. 4, 2011

(54) SCREW TIGHTENING DIAGNOSTIC DEVICE AND ELECTRIC DRIVER

(75) Inventor: Takami Ide, Itoigawa-shi (JP)

(73) Assignee: IDEKEIKI CO., LTD., Itoigawa-shi (JP)

(21) Appl. No.: 12/914,449

(22) Filed: Oct. 28, 2010

(30) Foreign Application Priority Data
Feb. 1, 2010 (JP) 2010-020575
Sep. 10, 2010 (JP) 2010-202952

(51) Int. Cl. B25B 23/147; G01L 5/24

(52) U.S. Cl. 81/479; 73/862.21

(57) ABSTRACT

The present invention provides a screw tightening diagnostic device which can easily and reliably detect a state of incomplete screw tightening and can allow reliable screw tightening work to be performed. The screw tightening diagnostic device comprises rotational torque detection means for detecting that rotational torque occurring in a rotating shaft of an electric driver has reached a preset rotational torque within a predetermined time range past a minimum required screw-tightening time that has been set in advance according to the length of the screw being tightened, pressure force detection means for detecting that pressure force created by the electric driver pressing the screw when the screw is being tightened has reached a preset pressure force, and screw tightening diagnostic means for diagnosing that screw tightening has been performed in a normal manner when the rotational torque detection means detects that the preset rotational torque has been reached within the predetermined time range past the minimum required time and the pressure force detection means has detected the preset pressure force.

### BACKGROUND OF THE INVENTION

1. Field of the Invention

The present invention relates to a screw tightening diagnostic device for diagnosing screw-tightening work by an electric driver, and also to an electric driver that uses this device.

2. Description of the Related Art

Various electric drivers have been proposed for efficiently tightening screws and the like. Among these types, there has been proposed an electric driver wherein a mechanical or electromagnetic clutch mechanism is provided between an electric motor and a driver chuck for mounting a driver bit for tightening a screw, and more precise tightening is made possible either by stopping the driving of the electric motor when the screw is tightened up to the seating of the screw bearing surface and the screw tightening torque reaches or exceeds a set value, or by driving the electric motor intermittently (for example, see Japanese Patent Publication No. 3663638 and Japanese Laid-open Patent Application No. 2005-238418).

However, with this type of electric driver, the rotation of the driver bit stops and the screw is completely tightened due to the screw being tightened to a tightening torque equal to or greater than the set value, but since the operator ultimately holds the electric driver in hand and tightens the screw while keeping the driver bit pressed into the screw, the tightened state of the screw will be significantly different depending on the operator or, with the same operator, depending on differences in the shapes of the driver bits, the tightening direction, the extent of the pressing force, the timing at which the screw stops being tightened, and other factors. There are also instances of insufficient or excessive tightening of the screw, as well as inconveniences such as an excessively long screw impacting another component, or galling and stripping, and such forms of unsatisfactory screw tightening are sometimes not discerned at first glance and are often overlooked after the device type has been assembled.

To reduce such unsatisfactory screw tightening at a manufacturing site, as a result of analyzing unsatisfactory screw tightening phenomena, the inventors discovered that most incidents of unsatisfactory screw tightening can be improved by controlling and managing not the screw tightening torque, i.e., the extent of the rotational torque occurring in the rotating shaft of the electric driver, but instead controlling and managing the tightening time; and the inventors have proposed a device of an electric driver that prevents against forgetting to tighten the screw, whereby efficient screw tightening work is made possible and reliable screw tightening work can be performed by judging the quality of the screw tightening work immediately after the work has been performed (Japanese Patent Publication No. 4295063).

According to this device, a tightening minimum required time is set in accordance with screw length, and the state of the screw tightening is diagnosed according to whether or not the rotational torque occurring in the rotating shaft of the electric driver reaches the preset rotational torque within a screw tightening completion judgment period in a predetermined time range past the minimum required time, and also whether or not the screw can be completely tightened. Unsatisfactory screw tightening is detected from this diagnosis, a count is taken of the number of times the screw tightening work has been judged to have no such problems, and this number is checked against a planned work number, whereby the screw tightening work state can be managed and evaluated, unsatisfactory screw tightening can be improved, the operator need not be mindful about tightening the screw.

### SUMMARY OF THE INVENTION

However, even with this device, since the operator ultimately holds the electric driver in hand and tightens a screw while keeping the driver bit pressed into the screw, the extent of the pressing force differs between operators, or even the same operator, as well as on differences in the shapes of the driver bits being used, and the operator will perform the screw tightening work repeatedly during screw tightening. This has led to instances in which the operator has tended to reflexively or unconsciously lift the electric driver off of the screw just before the tightening is complete, causing the tightening of the screw to be incomplete, and often causing the screw to be slightly lifted, which makes the screw tightening insufficient. A screw that is not completely tightened may come loose over time and cause various problems.

An object of the present invention is to provide a screw tightening diagnostic device which simply and reliably detects incomplete screw tightening while facilitating reliable screw tightening work, and to contribute to improving the reliability and safety of various manufactured devices.

A summary of the present invention is described with reference to the accompanying drawings.

The present invention relates to a screw tightening diagnostic device for performing a diagnosis on a tightened state of a screw when a screw has been tightened using an electric driver, the screw tightening diagnostic device comprising rotational torque detection means for detecting that rotational torque occurring in a rotating shaft of the electric driver has reached a preset rotational torque within a predetermined time range past a minimum required screw-tightening time that has been set in advance according to a length of the screw being tightened, pressure force detection means for detecting that pressure force created by the electric driver pressing the screw when the screw is being tightened has reached a preset pressure force, and screw tightening diagnostic means for diagnosing that screw tightening has been performed in a normal manner when the rotational torque detection means detects that the preset rotational torque has been reached within the predetermined time range past the minimum required time and the pressure force detection means has detected the preset pressure force.

The present invention also relates to a screw tightening diagnostic device according to a first aspect wherein the screw tightening diagnostic means is configured so as to diagnose that screw tightening has been performed properly when the rotational torque detection means has detected that the preset rotational torque has been reached within the predetermined time range past the minimum required time and the pressure force detection means has detected the preset pressure force.

The present invention also relates to a screw tightening diagnostic device according to the first aspect wherein the pressure force detection means is composed of a pressure force sensor for sensing the pressure force occurring due to the electric driver pressing the screw, and a pressure force identification unit for identifying that the pressure force sensed by the pressure force sensor has reached a preset pressure force.

The present invention also relates to a screw tightening diagnostic device according to the second aspect wherein the pressure force detection means comprises a pressure force sensor for sensing the pressure force occurring due to the electric driver pressing the screw, and a pressure force identification unit for detecting that the pressure force sensed by the pressure force sensor has reached a preset pressure force.

The present invention also relates to a screw tightening diagnostic device according to a third aspect comprising the electric driver, the electric driver being provided with the pressure force sensor.

The present invention also relates to a screw tightening diagnostic device according to a fourth aspect comprising the electric driver, the electric driver being provided with the pressure force sensor.

The present invention also relates to the screw tightening diagnostic device according to the first aspect, wherein the rotational torque detection means comprises a rotational torque sensor for sensing the rotational torque occurring due to the screw being turned by the electric driver, the screw tightening diagnostic device comprising the electric driver, and the electric driver being provided with the rotational torque sensor.

The present invention also relates to the screw tightening diagnostic device according to the second aspect, wherein the rotational torque detection means comprises a rotational torque sensor for sensing the rotational torque occurring due to the screw being turned by the electric driver, the screw tightening diagnostic device comprising the electric driver, and the electric driver being provided with the rotational torque sensor.

The present invention also relates to the screw tightening diagnostic device according to the fifth aspect, wherein the rotational torque detection means comprises a rotational torque sensor for sensing the rotational torque occurring due to the screw being turned by the electric driver, the screw tightening diagnostic device comprising the electric driver, and the electric driver being provided with the rotational torque sensor.

The present invention also relates to the screw tightening diagnostic device according to the sixth aspect, wherein the rotational torque detection means comprises a rotational torque sensor for sensing the rotational torque occurring due to the screw being turned by the electric driver, the screw tightening diagnostic device comprising the electric driver, and the electric driver being provided with the rotational torque sensor.

The present invention also relates to the screw tightening diagnostic device according to the first aspect, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

The present invention also relates to the screw tightening diagnostic device according to the second aspect, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

The present invention also relates to the screw tightening diagnostic device according to the fifth aspect, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

The present invention also relates to the screw tightening diagnostic device according to the sixth aspect, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

The present invention also relates to the screw tightening diagnostic device according to the seventh aspect, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

The present invention also relates to the screw tightening diagnostic device according to the eighth aspect, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

The present invention also relates to the screw tightening diagnostic device according to the ninth aspect, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

The present invention also relates to the screw tightening diagnostic device according to the tenth aspect, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

The present invention also relates to an electric driver comprising the screw tightening diagnostic device according to any of the first through eighteenth aspects.

The present invention also relates to the electric driver according to a nineteenth aspect, comprising drive current detection means for detecting a drive current for driving an electric motor of the electric driver and a rate of drive rotation of the electric motor, and further comprising drive force decline diagnostic means for calculating a drive torque of the electric motor from the drive current and the rate of drive rotation detected by the drive current detection means, sensing the rotational torque of the rotating shaft of the electric driver via the rotational torque sensor provided to the rotational torque detection means, and comparing the calculated drive torque with the rotational torque sensed via the rotational torque sensor to diagnose a decline in a drive force of the electric driver.

The present invention also relates to the electric driver according to a nineteenth aspect, wherein the electric driver has a clutch for cutting off transmission of the rotational torque of the electric driver when the rotational torque occurring in the rotating shaft of the electric driver has reached a preset cutoff rotational torque, the clutch is provided with a cutoff torque adjustment mechanism for variably setting the cutoff rotational torque, and the screw tightening diagnostic device comprises a setting unit that can set the cutoff rotational torque of the cutoff torque adjustment mechanism via remote operation.

The present invention also relates to the electric driver according to a twentieth aspect, wherein the electric driver has a clutch for cutting off transmission of the rotational torque of the electric driver when the rotational torque occurring in the rotating shaft of the electric driver has reached a preset cutoff rotational torque, the clutch is provided with a cutoff torque adjustment mechanism for variably setting the cutoff rotational torque, and the screw tightening diagnostic device comprises a setting unit that can set the cutoff rotational torque of the cutoff torque adjustment mechanism via remote operation.

Since the present invention is configured as described above, it is possible to detect that screw tightening has been properly performed from the rotational torque occurring in the rotating shaft of the electric driver and the pressure force created by the electric driver pressing the screw, and as a result, the screw tightening work can be forced even when screw tightening is complete so that the screw is pressed reliably, the screw tightening diagnostic device is capable of reducing the incidence of incomplete screw tightening as much as possible and facilitating reliable screw tightening work, and the screw tightening diagnostic device can contribute to improving the reliability of various devices that are manufactured using an electric driver that uses the screw tightening diagnostic device.

The invention according to the second aspect is a screw tightening diagnostic device in which a diagnosis is made that proper screw tightening has been performed by detecting that the preset pressure force is being maintained when the preset rotational torque has been reached, and a more reliable screw tightening diagnosis can be made.

In the invention according to the third and fourth aspects, it is possible with a simple configuration to achieve a pressure force detection means which can reliably detect that the preset pressure force has been reached.

In the invention according to the fifth and sixth aspects, the pressure force can be detected effectively because the pressure force sensor can be provided to a location (e.g., in the drive structure or the like) where the pressure force occurring due to the electric driver pressing the screw can be accurately detected.

In the invention according to the seventh through tenth aspects, rotational torque can be detected effectively because it is possible with a simple configuration to achieve rotational torque detection means capable of reliably detecting that the preset rotational torque has been reached, and the rotational torque sensor can be provided to a location (e.g., in the drive structure or the like) where the rotational torque occurring in the rotating shaft of the electric driver can be accurately detected.

In the invention according to the eleventh through eighteenth aspects, the screw tightening diagnostic device can contribute to more efficient screw tightening because it is possible to set various set values which are set in advance in the electric driver in accordance with various screw types and screw tightening work, for example, which makes the device more convenient, and a notification is made of the screw tightening diagnosis result, allowing the quality of the screw tightening to be quickly determined.

In the invention according to the nineteenth aspect, a reliable diagnosis of the screw tightening work can be made quickly, and the electric driver is capable of performing reliable screw tightening work.

In the invention according to the twentieth aspect, since a decline in the drive force of the electric driver can be diagnosed, the reliability of the electric driver itself can be easily confirmed, and the reliability of the screw tightening diagnosis can be further improved.

In the invention according to the twenty-first and twenty-second aspects, a more practical electric driver is achieved in which the cutoff rotational torque of the clutch of the electric driver can varied to adapt to various types of work of different screw tightening strength specifications, which makes the electric driver more convenient, and it is easily possible to systematically manage and control multiple electric drivers, for example, because the cutoff rotational torque can be set by remote operation.

### BRIEF DESCRIPTION OF THE DRAWINGS

FIG. 1 is a configuration diagram of an electric driver management system according to the present embodiment;

FIG. 2 is an explanatory diagram of the screw tightening action by the electric driver according to the present embodiment;

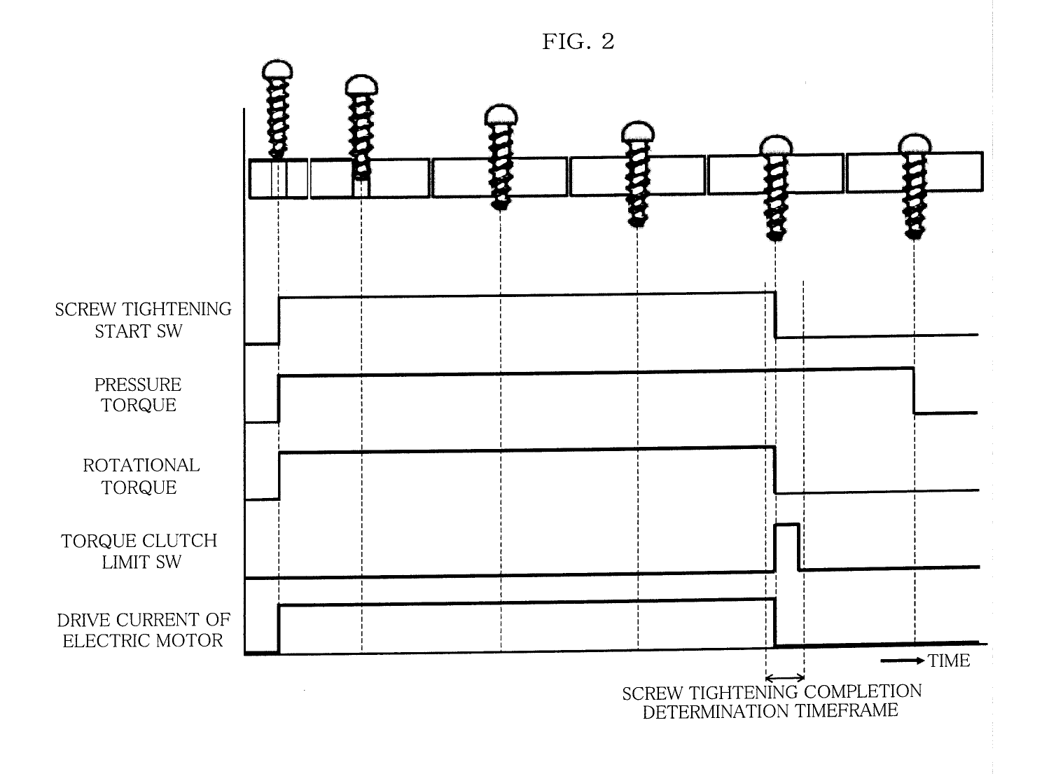

FIG. 3 is an explanatory diagram of judgment on the rotational torque from the electric driver according to the present embodiment;

FIG. 4 is an explanatory diagram of the tightening of a screw by the electric driver according to the present embodiment; and

FIG. 5 is an explanatory diagram of the clutch of the electric driver according to the present embodiment.

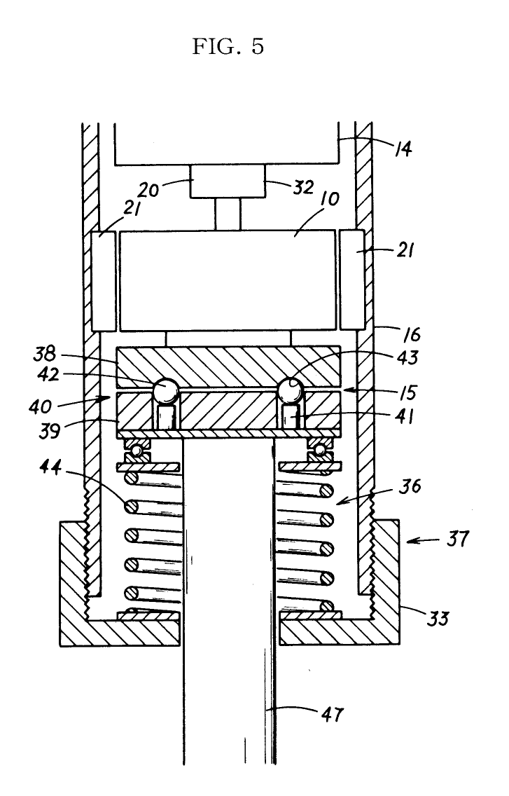

### DESCRIPTION OF THE PREFERRED EMBODIMENTS

Preferred embodiments of the present invention are described in a simple manner while referencing the drawings and demonstrating the action of the present invention.

For example, according to the length of a screw 2 being tightened, the minimum required screw-tightening time whereby tightening can be determined to be complete, the predetermined time range past this minimum required screw-tightening time, and the rotational torque occurring in the rotating shaft of an electric driver 1 are set in advance in the rotational torque detection means.

The pressure force whereby it is possible to determine that the screw 2 can be completely tightened all the way is also set in advance in the pressure force detection means.

Therefore, when the screw 2 is tightened using the electric driver 1, when the rotational torque occurring in the rotating shaft of the electric driver 1 reaches the preset rotational torque within the predetermined time range past the preset minimum required screw-tightening time, it is detected by the rotational torque detection means, whereby it can be confirmed that tightening of the screw 2 is complete.

When the pressure force occurring due to the electric driver 1 pressing the screw 2 reaches the preset pressure force, it is detected by the pressure force detection means, whereby it is possible to confirm that sufficient pressure force has been added in order to completely tighten the screw 2 all the way.

In view of this, in the present invention, when the rotational torque detection means detects that the preset rotational torque has been reached within the predetermined time range past the minimum required time and the pressure force detection means detects the preset pressure force, screw tightening diagnostic means 5 diagnoses that screw tightening has been performed properly.

Therefore, when the rotational torque reaches the preset rotational torque within the predetermined time range and screw tightening is properly performed so as to yield the preset pressure force, it is diagnosed that screw tightening has been performed properly. When screw tightening is performed based on this diagnosis result, the screw tightening can be forced so that the screw is reliably pressed when screw tightening is complete, and the screw tightening diagnostic device is therefore capable of reducing the incidence of incomplete screw tightening as much as possible and of facilitating more reliable screw tightening. Furthermore, the screw tightening diagnostic device can contribute to improving the reliability of various devices manufactured using the electric driver 1.

The screw tightening diagnostic means 5 is a screw tightening diagnostic device which can more reliably perform a screw tightening diagnosis, because when the rotational torque detection means has detected that the preset rotational torque has been reached within the predetermined time range past the minimum required time and the pressure force detection means has detected the preset pressure force, for example, in cases in which the diagnosis is configured to take place when screw tightening has been performed properly, the screw 2 is reliably pressed by the electric driver 1 at the very point in time at which the rotational torque reaches the preset rotational torque and the screw tightening is completed, whereby it is guaranteed that screw tightening has been reliably performed all the way.

In cases in which, for example, the pressure force detection means is configured comprising a pressure force sensor 22 for detecting the pressure force occurring to the electric driver 1 pressing the screw 2 and a pressure force identification unit 4 for detecting that the pressure force sensed by the pressure force sensor 22 has reached the preset pressure force, when the screw 2 is pressed by the electric driver 1, the pressure force sensor 22 provided to the electric driver 1 can be provided to a location whereby the pressure force occurring during this pressure can be sensed easily and effectively, the pressure force identification unit 4 for distinguishing the pressure force detected by the pressure force sensor 22 can also be applied to an appropriate location, and pressure force detection means capable of reliably detecting the pressure force occurring due to the electric driver 1 pressing the screw 2 can be achieved with a simple configuration.

In cases in which the pressure force sensor 22 is provided to the electric driver 1, for example, the pressure force sensor can be provided to a location (e.g., in the drive structure or the like) whereby the pressure force occurring due to the electric driver 1 pressing the screw 2 can be reliably and accurately detected, and the pressure force can therefore be detected effectively.

In cases in which, for example, the rotational torque detection means is composed of a rotational torque sensor 21 for sensing the rotational torque occurring due to the electric driver 1 turning the screw 2 and the electric driver 1 is included which is provided with the rotational torque sensor 21, rotational torque detection means capable of reliably detecting that the preset rotational torque has been reached can be achieved with a simple configuration, and, moreover, the rotational torque sensor can be provided to a location (e.g., in the drive structure or the like) where the rotational torque occurring in the rotating shaft of the electric driver can be accurately detected; therefore, the rotational torque can be detected effectively.

In cases in which, for example, the screw tightening diagnostic device comprises a setting unit 48 for setting the minimum required screw-tightening time, the predetermined time range, and the rotational torque which are set in advance in the rotational torque detection means, as well as the pressure force set in advance in the pressure force detection means; and also a notification unit 6 for issuing a notification of the result of the screw tightening diagnosis made by the screw tightening diagnostic means 5; the preset minimum required screw-tightening time, predetermined time range, rotational torque, and pressure force can, for example, be set by the setting unit 48 in a single location in accordance with various screw types and the screw tightening work, for example; and screw tightening can be efficiently performed because a notification of the screw tightening diagnosis result can be made by the notification unit 6, e.g., a buzzer, a light, or the like, enabling the screw tightening diagnosis result to be perceived directly, which makes the screw tightening diagnostic device easily operable and highly convenient.

In cases in which, for example, the electric driver 1 is equipped with a screw tightening diagnostic device, when the preset rotational torque, minimum required screw-tightening time, predetermined time range, pressure force, and other parameters are set in advance, for example, the electric driver is capable of performing highly reliably screw tightening work easily, quickly, and reliably.

In cases in which, for example, the screw tightening diagnostic device comprises drive current detection means 7 for detecting a drive current for driving an electric motor 14 of the electric driver 1 and the drive rotational speed of this electric motor 14, and also drive force decline diagnostic means 8 for calculating the drive torque of the electric motor 14 from the drive current and drive rotational speed detected by the drive current detection means 7, sensing the rotational torque of the rotating shaft of the electric driver 1 via the rotational torque sensor 21 provided to the rotational torque detection means, and comparing the calculated drive torque with the rotational torque sensed via the rotational torque sensor 21 to diagnose the decline of the drive force of the electric driver 1, a decline in the drive force of the electric driver 1 can be diagnosed when the drive torque of the electric motor 14 calculated from the drive current detected by the drive current detection means 7 and the drive rotational speed is compared with the rotational torque detected by the rotational torque sensor 21. Therefore, it is possible to quickly discover reductions in the rotational torque of the electric driver 1 or failures of the electric motor, the gears, or the clutch, for example; it is possible to quickly confirm whether the electric driver 1 is operating normally or abnormally, and as well as of course improving the reliability of the electric driver itself, it is also possible to improve the reliability of the screw tightening work.

In cases in which, for example, the electric driver 1 comprises a clutch 15 for cutting off the transmission of the rotational torque of the electric driver 1 when the rotational torque in the rotating shaft of the electric driver 1 reaches a preset cutoff rotational torque, the clutch 15 is provided with a cutoff torque adjustment mechanism 37 for variably setting the cutoff rotational torque, and the setting unit 48 is provided which can set the cutoff rotational torque of the cutoff torque adjustment mechanism 37 by remote operation; the cutoff rotational torque can be set in the clutch 15 of the electric driver 1 when the cutoff rotational torque is remotely set into the cutoff torque adjustment mechanism 37 from the setting unit 48, for example; therefore, with this electric driver, the cutoff rotational torque of the clutch of the electric driver can be varied to allow for various types of work having different screw tightening strength specifications, making the driver more convenient; the cutoff rotational torque can be set remotely and reliably, and, furthermore, cutoff rotational torques of multiple electric drivers 1, can be managed collectively, for example.

### WORKING EXAMPLES

Specific working examples of the present invention are described with reference to the drawings.

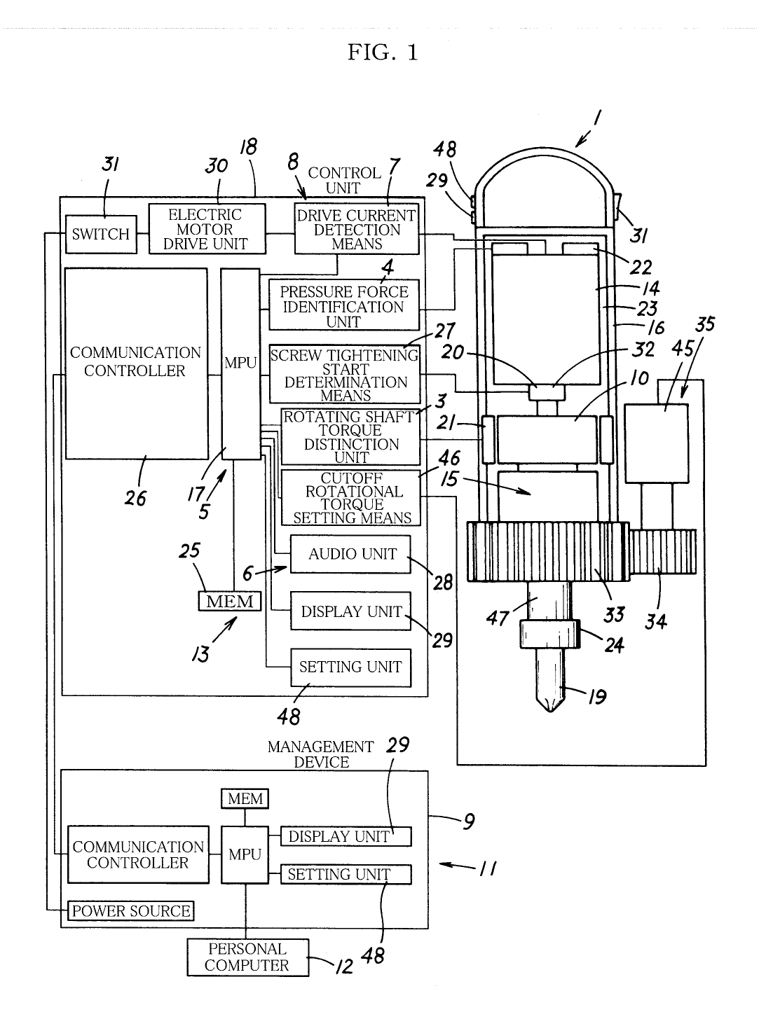

The present working example is applied to the electric driver management system 11 shown in FIG. 1, wherein a screw tightening diagnostic device 13 is provided for diagnosing the work quality of a screw tightening work whereby a screw 2 is tightened by the electric driver 1, the screw tightening diagnostic device 13 is installed in the electric driver 1, and the screw tightening process is managed in a manufacturing line in which screw tightening is performed using the electric driver 1.

Specifically, this electric driver management system 11 is configured from the electric driver 1 comprising the screw tightening diagnostic device 13, a management device 9, and a personal computer 12, and is used to perform work management in order to improve the quality of screw tightening work. The electric driver management system 11 diagnoses whether screw tightening work is normal or abnormal and manages the screw tightening process in the manufacturing line according to whether or not the screw tightening work occurs at a screw tightening timing to the extent stipulated by the preset rotational torque (rotating shaft torque) occurring in the rotating shaft of the electric driver 1 and pressure force occurring due to the electric driver 1 pressing in on the screw 2.

The screw tightening diagnostic device 13 comprises rotational torque detection means for detecting that the rotational torque occurring in the rotating shaft of the electric driver 1 has reached a preset rotational torque within a predetermined time range past the minimum required screw-tightening time that has been set in advance according to the length of the screw being tightened, pressure force detection means for detecting that the pressure force occurring due to the electric driver 1 pressing the screw 2 when the screw is being tightened has reached the preset pressure force, and screw tightening diagnostic means 5 for diagnosing that screw tightening has been performed properly when the rotational torque detection means has detected that the preset rotational torque has been reached within the predetermined time range past the minimum required time and the pressure force detection means has detected the preset pressure force.

The rotational torque detection means constitutes means for detecting the rotational torque occurring in the rotating shaft of the electric driver 1, and the rotational torque detection means is composed of the rotational torque sensor 21 for sensing the rotational torque and a rotational torque identifying unit 3 for distinguishing the rotational torque, wherein the rotational torque sensor 21 is provided to the electric driver 1.

Specifically, the rotational torque sensor 21 is configured such that a magnetostrictive torque sensor is provided to the external periphery of the clutch 15 of the electric driver 1, described hereinafter; a rotational torque signal from this magnetostrictive torque sensor is sensed, the rotational torque signal is inputted to the rotational torque identifying unit 3 provided in a controller 18, and the rotational torque identifying unit 3 compares this signal with a rotational torque threshold corresponding to the preset rotational torque, thereby detecting whether or not the rotating shaft occurring in the rotating shaft of the electric driver 1 has reached the preset rotational torque.

The rotational torque identifying unit 3 determines that a maximum torque detection is in effect when the rotational torque sensed by the rotational torque sensor 21 provided to the clutch 15 has reached the preset rotational torque, provides a screw tightening completion determination timeframe for determining that screw tightening is complete within the predetermined time range past the minimum required screw-tightening time which is set in advance according to the type and length of the screw being tightened, and determines that screw tightening is complete when the maximum torque is detected during this screw tightening completion determination timeframe.

Furthermore, this rotational torque identifying unit 3 detects a rotational torque dropping point at which the rotational torque suddenly decreases in a dropping manner after the preset rotational torque has been detected, and detects the rotational torque dropping point during the screw tightening completion determination timeframe, thereby performing a more reliable rotational torque determination.

Specifically, this rotational torque identifying unit 3 comprises a counter for counting the time duration from the point in time at which a screw tightening start switch 20 of the electric driver 1 is turned on by the electric driver 1 pressing the screw 2 and the electric motor 14 starts driving, the turning on of the screw tightening start switch 20 causes the counter to produce a screw tightening completion determination timeframe signal within the predetermined time range past the minimum required screw-tightening time, and the counter is reset when the rotational torque occurring in the rotating shaft of the electric driver 1 reaches the preset rotational torque, the clutch 15 is disengaged, and the electric motor 14 is stopped by a torque clutch limit switch 32.

As a result, the signal sensed by the rotational torque sensor installed in the electric driver 1 is compared with the rotational torque threshold corresponding to the preset rotational torque by the rotational torque identifying unit 3, and a determination is made as to whether or not the preset rotational torque has been reached.

The pressure force detection means is composed of a pressure force sensor 22 for detecting the pressure force created by the electric driver 1 pressing the screw 2, and a pressure force identification unit 4 for comparing the detected pressure force with a pressure force threshold corresponding to the preset pressure force, whereby the pressure force is identified.

The pressure force sensor 22 is provided within the electric driver 1, a piezoelectric sheet is used as the pressure force sensor 22, a housing component 23 for housing the electric motor 14 is provided inside a casing 16 of the electric driver 1, and the piezoelectric sheet is provided so as to be sandwiched between part of a side surface of the housing component 23 and a surface of the electric motor 14 on the side opposite a reducer 10 or the clutch 15, whereby the electric motor 14 presses into the piezoelectric sheet 22 when the electric driver 1 presses into the screw 2 during screw tightening, the pressure force thereof creates voltage in the piezoelectric sheet 22, and this voltage is directly detected as a pressure force signal.

As a result, the pressure signal sensed by the pressure force sensor 22 due to the electric driver 1 pressing the screw 2 is compared with the pressure force threshold by the pressure force identification unit 4, and an identification determination is made as to whether or not the preset pressure force threshold has been reached.

The pressure force threshold of the pressure force identification unit 4 of the present working example includes two types of pressure force thresholds, one for determining the upper limit of the pressure force and one for determining the lower limit, and it is determined that an appropriate pressure force is applied when the pressure force signal sensed by the pressure force sensor 22 is within a pressure force range determined by the upper and lower limit thresholds, but the pressure force threshold may also comprise a lower limit threshold alone.

In the present working example, providing these upper and lower limit pressure force thresholds allows appropriate pressure force detection to be performed, and a warning is produced by the hereinafter-described notification unit 6 when the pressure force is either excessive or insufficient.

Furthermore, this pressure force identification unit 4 has an acceleration sensor and a setting function for selecting the operation direction between up and down, and the distinction action of the pressure force identification unit 4 is performed with the pressure force threshold having been automatically varied according to the orientation of the electric driver 1 in which the bit of the electric driver 1 is pointed upward or downward, whereby the pressure force distinction is not limited by the orientation of the electric driver 1.

Thus, providing the pressure force identification unit 4 with an acceleration sensor makes it possible to detect the direction of gravity; therefore, if the up/down operating direction of the electric driver 1 is established in advance according to the setting function for selecting the up/down operating direction, the pressure force can be correctly determined whether the electric driver 1 be oriented up or down.

When the rotational torque identifying unit 3 in the rotational torque detection means determines that the rotational torque has reached the preset rotational torque within the screw tightening completion determination timeframe of the predetermined time range past the preset minimum required screw-tightening time, the screw tightening diagnostic means 5 diagnoses that screw tightening work has been performed properly in cases in which the pressure force that has reached the preset pressure force is distinguished by the pressure force identification unit 4 in the pressure force detection means and the preset pressure force is maintained for a predetermined timeframe that has been set in advance, otherwise the screw tightening diagnostic means 5 diagnoses that screw tightening work has not been properly performed. The screw tightening diagnostic means 5 thereby guarantees that when tightening is complete, an appropriate pressure force has been applied and screw tightening has been performed correctly.

Specifically, after the preset rotational torque has been reached within the screw tightening completion determination timeframe, the pressure force identification unit 4 determines that the pressure force meets the preset pressure force even after the rotational torque identifying unit 3 has determined that the rotational torque has dropped and screw tightening is complete, and it is diagnosed that the screw tightening work has been performed properly when the pressure force is maintained for the preset time duration, thereby making an even more reliable diagnosis possible.

In other words, when the rotational torque identifying unit 3 determines that the rotational torque has reached the preset rotational torque within the screw tightening completion determination timeframe, the pressure force that meets the preset pressure force is identified by the pressure force identification unit 4. It is diagnosed that the screw tightening work has been performed properly in the case that the preset pressure force is maintained for the predetermined timeframe that has been set in advance, otherwise it is diagnosed that the screw tightening work has not been properly performed.

When the screw 2 is pressed by the electric driver 1 to perform screw tightening using the screw tightening diagnostic device 13 having the configuration described above, when the rotational torque in the rotating shaft of the electric driver 1 reaches the preset rotational torque within the predetermined time range past the minimum required screw-tightening time set according to the length of the screw 2 being tightened, the electric driver 1 stops and the tightening of the screw 2 is complete. Furthermore, in cases in which it is detected that the screw 2 has been continually pressed with a pressure force meeting the preset pressure force during the screw 2 tightening completion time point and during a preset time duration continuing from this time point, it is diagnosed that the screw tightening work by the electric driver 1 has been performed properly. It is possible to diagnose that screw tightening has been performed improperly rather than properly in other circumstances, such as, e.g., cases in which the screw cannot be tightened at the predetermined timing due to screw slippage, galling, stripping, or other phenomena, or states in which the electric driver 1 is not properly pressing the screw at the completion of screw tightening.

Consequently, the screw tightening work is managed so that a rotational torque that meets the preset rotational torque is added within the predetermined time range and the preset pressure force is maintained for the predetermined time duration, whereby it is possible to reliably detect a state of incomplete screw tightening, and a diagnosis of the screw tightening state can be made.

The operator learns to perform screw tightening on the basis of the result of this diagnosis, whereby the operator can be compelled to cause pressure to be reliably applied to the screw 2 at completion of screw tightening, incomplete screw tightening can therefore be reduced as much as possible, and the screw tightening diagnostic device 13 causes screw tightening to be performed more reliably. This can also contribute to improving the reliability of various devices manufactured using an electric driver 1 comprising this screw tightening diagnostic device 13.

The screw tightening diagnostic device 13 also comprises data communication control means 26 for transferring data between the electric driver 1 and the hereinafter-described management device 9. The screw tightening diagnostic device 13 can receive from the management device 9 parameters set in advance in the electric driver 1, such as screw type, screw length, minimum required screw-tightening time, a predetermined time range as the screw tightening completion determination timeframe, rotational torque, pressure force, and the maintenance time duration of the pressure force; and can transmit to the management device 9 the screw tightening diagnosis results and specific diagnostic data, e.g., the sensed rotational torque, the sensed pressure force, a self-diagnosis result of the drive force of the electric driver 1, and parameters set and stored in advance, e.g., a set screw type, screw length, minimum required screw-tightening time or predetermined time range, rotational torque, pressure force, maintenance time duration of this pressure force, and the like. The drive force decline diagnostic means 8 is provided as the self-diagnosis means of the electric driver 1.

The drive force decline diagnostic means 8 comprises the drive current detection means 7 for detecting the drive current which drives the electric motor 14 of the electric driver 1 and the drive rotational speed of the electric motor 14, wherein the drive force decline diagnostic means 8 calculates the drive torque of the electric motor 14 from the drive current and drive rotational speed detected by the drive current detection means 7, senses the rotational torque in the rotating shaft of the electric driver 1 via the rotational torque sensor 21, and compares the calculated drive torque with the rotational torque obtained from the signal sensed by the rotational torque sensor 21 to perform a diagnosis on the electric driver 1 itself arising from such factors as a decline in the drive force of the electric motor 14 of the electric driver 1, or a decline in the rotational torque sensor 21, the pressure force sensor 22, or other sensors. A self-diagnosis of the electric driver 1 can be performed by switching to self-diagnosis mode, which is done by the setting unit 48 provided to the electric driver 1.

Therefore, the electric driver 1 can be self-diagnosed by determining whether the drive force has declined due to a reduction in the rotational torque of the electric motor 14 or some other cause, and the reliability of the screw tightening work can be quickly confirmed. It is therefore possible to reliably improve the reliability of the screw tightening work in the manufacturing site, in addition to the reliability of the electric driver 1 itself, as shall be apparent.

The screw tightness diagnostic device 13 is provided with a notification unit 6 for informing the management device 9 via the communication control means 26 of the result of the screw tightening diagnosis made by the screw tightening diagnostic means 5, and for issuing a notification, either audibly by the sounding of a buzzer provided to the electric driver 1 or visibly by a light display, whereby the result of the screw tightening diagnosis can be confirmed audibly by the sounding of a buzzer or visibly by a light display even during the screw tightening. Therefore, the diagnosis result can be immediately perceived and efficient screw tightening work can be performed.

In the electric driver 1, the electric motor 14, the reducer 10, and the clutch 15 are set up along the same axis and provided inside the tubular casing 16, and the rotational torque sensor 21 for sensing the rotational torque, the pressure force sensor 22 for sensing the pressure force, and the controller 18 are also provided inside the casing 16, whereby the sensors can be provided to appropriate locations in proximity to the areas inside the electric driver 1 where the rotational torque and pressure force occur, and the rotational torque and pressure force can be detected directly and effectively, simplifying the configuration.

The controller 18 is configured such that various electronic components constituting an MPU 17, a memory 25, the communication control means 26, the rotational torque detection means, the pressure force detection means, a screw tightening start determination means 27, a buzzer or another sounding unit 28 or a light or another display unit 29 as the notification unit 6 for the screw tightening diagnosis result, an electric motor drive unit 30 for supplying power to the electric motor 14, the drive current detection means 7 for detecting the drive current and drive rotational speed of the electric motor 14, and the like are installed on a printed circuit board, the functions of the screw tightness diagnostic device 13 are incorporated and executed as software, and the respective output signals of the rotational torque sensor 21 and the pressure force sensor 22 are identified and determined by the rotational torque identifying unit 3 and the pressure force identification unit 4 of the screw tightness diagnostic device 13 provided to the controller 18.

A brushless motor is used for the electric motor 14, which is configured such that a driver bit 19 provided to the distal end of the electric driver 1 is rotated by the rotation of the electric motor 14. Furthermore, between the electric motor 14 and the driver bit 19 are provided the reducer 10 composed of a planetary gear for reducing the rotational speed of the electric motor 14, and the clutch 15 for controlling the engaging and disengaging between the reducer 10 and the driver bit 19, the driver bit 19 being attached to the clutch 15 via a bit holder 47 and a chuck 24.

The clutch 15 is configured so as to cut off the transmission of rotational torque from the electric motor 14, the reducer 10, and other drive sources to the load side when the rotational torque during screw tightening reaches the preset rotational torque. The clutch 15 is also equipped with the screw tightening start switch 20 and the torque clutch limit switch 32, and when the electric driver 1 presses into the screw 2 and the screw tightening start switch 20 turns on, the electric motor 14 is driven, and when the preset rotational torque is reached and the clutch 15 cuts off the transmission, the driving of the electric motor 14 is stopped by the torque clutch limit switch 32.

The electric driver 1 is capable of diagnosing the result of the screw tightening on its own without connecting to the management device 9 once the parameters of the screw type, the screw length, the minimum required screw-tightening time, the predetermined time range as the determination timeframe, the rotational torque, the pressure force, and the maintained time duration of the pressure force have been set.

The electric driver 1 comprises the clutch 15 for cutting off the transmission of the rotational torque of the electric driver 1 when the rotational torque occurring in the electric driver 1 reaches the preset cutoff rotational torque, the clutch 15 is provided with the cutoff torque adjustment mechanism 37 for setting the cutoff rotational torque in advance, and the torque is stabilized at the preset cutoff rotational torque.

Furthermore, in the present working example, the cutoff torque adjustment mechanism 37 for variably setting the cutoff rotational torque of the clutch 15 is controlled from the personal computer 12 or the setting unit 48 of the management device 9, and the cutoff rotational torque of the clutch 15 of the electric driver 1 can be set remotely.

Specifically, the configuration is designed so that the cutoff torque adjustment mechanism 37 is provided to a torque pressure adjustment mechanism 36 of the clutch 15, the cutoff torque value of the clutch 15 can be variably set to a preset value when the cutoff rotational torque is set by a setting unit of the management device 9 or of the personal computer 12, and the torque clutch pressure of the clutch 15 of the electric driver 1 can be adjusted to cut off the clutch 15 at a predetermined cutoff rotational torque by issuing or sending the preset cutoff rotational torque to the electric driver 1 from the management device 9 or the personal computer 12.

Specifically, the clutch 15 of the electric driver 1 comprises a drive member 38 linked to the drive source side of the electric motor 14, the reducer 10, or the like; a driven member 39 linked to the driven side of the chuck 24, the driver bit 19, and other components; and a cam mechanism 40 between the drive member 38 and the driven member 39. The torque pressure adjustment mechanism 36 is also provided, which is capable of adjusting the torque pressure by pressing the driven member 39 against the drive member 38 via the predetermined elastic force of a spring 44, and the cutting off of the link between the drive side and the driven side is controlled at a predetermined rotational torque.

Furthermore, specifically, the cam mechanism 40 of the clutch 15 is configured from cam rods 41, rigid balls 42, and grooves 43 for holding the rigid balls 42, the torque pressure adjustment mechanism 36 is provided, which is capable of adjusting the torque pressure by pressing the driven member 39 against the drive member 38 with a predetermined elastic pressure of the spring 44, the rigid balls 42 engage with the grooves 43 and the torque of the drive member 38 is transmitted to the driven member 39 when the driven member 39 is pressed against the drive member 38, and when the rotational torque reaches the predetermined cutoff rotational torque set in advance by the torque pressure adjustment mechanism 36, the rigid balls 42 and the grooves 43 disengage and the torque transmission is cut off.

In the present working example, the cutoff torque adjustment mechanism 37 is configured by providing a lever gear 33 to the external periphery of the holding part of the spring 44 constituting the torque pressure adjustment mechanism 36 of the clutch 15, the lever gear 33 is provided to the external surface of the electric driver 1, and the spring 44 can be stretched and the elastic force of the spring 44 can be varied when the lever gear 33 is turned by a predetermined angle, whereby the cutoff rotational torque can be adjusted and set.

Furthermore, a torque adjustment electric motor 35 for setting the cutoff rotational torque of the electric driver 1 is provided, the torque adjustment electric motor 35 is linked to the lever gear 33 of the electric driver 1, and the cutoff rotational torque of the electric driver 1 can be variably set as appropriate by turning the torque adjustment electric motor 35 by a predetermined angle via a command from the management device 9.

The torque adjustment electric motor 35 has an adjustment gear 34 provided to a rotating shaft of a stepping motor 45, and the cutoff rotational torque of the electric driver 1 can be set to an appropriate value when the adjustment gear 34 is engaged with the lever gear 33 of the electric driver 1 and the stepping motor 45 is caused to rotate a predetermined angle.

The present working example is configured so that the controller 18 installed in the electric driver 1 is provided with cutoff rotational torque setting means 46 for producing a pulse signal to be applied to the stepping motor 45 to specify the rotational angle and set the cutoff rotational torque of the clutch 15, the cutoff rotational torque is specified to the torque adjustment electric motor 35 by the management device 9 or the personal computer 12, and the controller 18 of the electric driver 1 is informed of this set cutoff rotational torque, whereby the cutoff rotational torque of the clutch 15 of the electric driver 1 can be adjusted or set.

Since the present working example is configured in this manner, when the cutoff rotational torque is specified and sent to the electric driver 1 from the management device 9 or the personal computer 12, the rotational angle corresponding to the cutoff rotational torque is calculated by the cutoff rotational torque setting means 46 via the communication control means 26 provided to the controller 18, and when the stepping motor 45 of the torque adjustment electric motor 35 rotates by this rotational angle, the cutoff torque adjustment mechanism 37 linked to the adjustment gear 34 by the lever gear 33 turns, the spring 44 provided to the torque pressure adjustment mechanism 36 is displaced, adjusting the torque pressure, and the torque clutch pressure of the clutch 15 of the electric driver 1 is adjusted, allowing the clutch 15 to be operated at the predetermined cutoff rotational torque.

Therefore, an electric driver and an electric driver management system are achieved in which it is possible to appropriately set the torque of an electric driver 1 used in a screw tightening process at a manufacturing site, the torque can be calibrated, adjusted, and otherwise managed collectively, and operation management of the screw tightening process can be performed in a more reliable manner.

The management device 9 and the personal computer 12 are configured so that the screw type, screw length, minimum required screw-tightening time, predetermined time range as the screw tightening completion determination timeframe, rotational torque, pressure force, maintained time of pressure force, and other various parameters set in advance according to the screw tightening work specifics are set by the setting unit 48, and these parameters are transmitted to the screw tightness diagnostic device 13 installed in the electric driver 1 and set remotely. In addition to this, the results of the screw 2 being tightened and diagnosed by the electric driver 1, as well as various parameters and data stored in the electric driver 1, are read and confirmed, various data transmitted from the electric driver 1 is stored, processed, and displayed, and various types of screw tightening work and processes performed by the electric driver 1 can be managed.

With the electric driver management system 11 of the present working example, which is configured from the electric driver 1, the management device 9, and the personal computer 12 as described above, the screw type, screw length, minimum required screw-tightening time, predetermined time range, rotational torque, pressure force, time of maintained pressure force, and other parameters are set in advance using the PC 12, and these parameters are sent to the electric driver 1 and inputted into the electric driver 1 via the management device 9. Next, when screw tightening work is performed, the determined diagnosis result of the screw tightening work can be immediately confirmed by a light, buzzer, or other notification means 6 while the screw is being tightened, and the diagnosis result is transmitted to the management device 9 or the personal computer 12. The data measured for the rotational torque, the pressure force, the time of maintained pressure force, the drive current, the rate of drive rotation, and other data at the time of screw tightening are transmitted as time-series data, whereby the screw tightening process can be managed by analyzing various statistics and changes over time in the screw tightening state from the time-series data, for example, via the management device 9 or the personal computer 12.

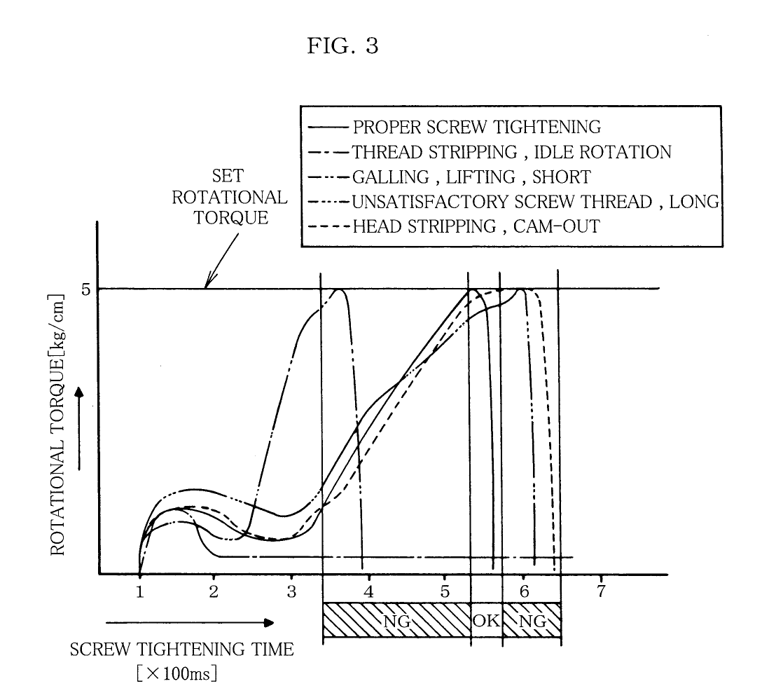

FIG. 3 is a schematic depiction of the changes over time in rotational torque and pressure force when screw tightening work is performed by the electric driver 1, using the electric driver management system 11 of the present working example. In this case, 540 milliseconds is the minimum required time for screw tightening using a M3×6 mm screw 2, and a screw tightening completion determination timeframe is provided for which screw tightening completion is determined within the predetermined time range past this minimum required time.

In the case of problems such as screw slippage; “galling,” in which the screw catches in the receiving thread; the screw thread being unsatisfactory; and the screw head being stripped, screw tightening is not performed properly if the screw tightening time is within the screw tightening completion determination timeframe, and the screw tightening is therefore diagnosed as abnormal, as shown in FIG. 3. In the present working example, not only is screw tightening performed within the screw tightening completion determination timeframe, but the application of a predetermined amount of pressure is also detected when the screw 2 is pressed by the electric driver 1, and it is diagnosed that proper screw tightening has been performed.

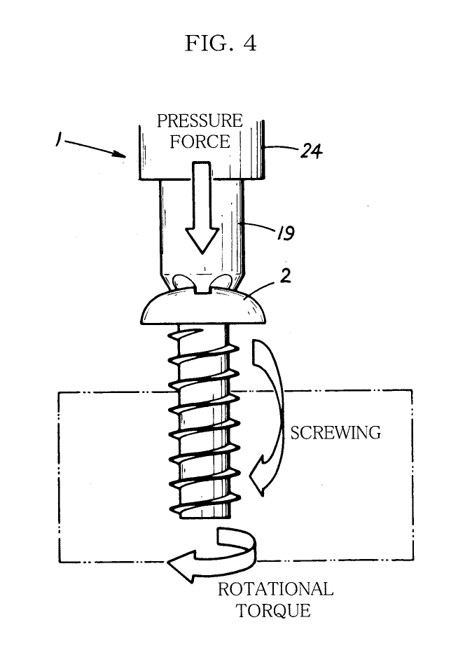

Specifically, when the screw 2 is screwed in by the electric driver 1, the screwing force is required to have a propulsive force from the pressing of the screw 2 as shown in FIG. 4, but in the present working example, the quality of the screw tightening can be accurately evaluated and diagnosed by detecting both the pressure force, which is a pressure direction component of the screwing force, and the rotational torque, which is a component orthogonal to the pressure force; i.e., by evaluating not only the rotational torque occurring in the rotating shaft of the electric driver 1 when the screw 2 is tightened by the electric driver 1, but also the pressure force occurring due to the electric driver 1 pressing the screw 2, and particularly the pressure force that is the final twist at the completion of screw tightening as well as the maintained time of this pressure force.

In the present working example, an electric driver 1 is obtained incorporating a screw tightening diagnostic device 13 for correctly representing the screw tightening outcome by diagnosing whether or not a screw has been completely tightened within a preset time period at a preset pressure force. As a result, not only can the resulting electric driver management system 11 perceive and manage the screw tightening work conditions at, for example, the manufacturing site, but a very highly reliable screw tightening process can be achieved by developing expertise in the screw tightening work so as to conform to the diagnosis, and the reliability and safety of various devices manufactured using this electric driver 1 can therefore be improved.

With the electric driver 1 of the present working example, the rotational torque of the electric motor 14 relative to the predetermined pressure force is confirmed by the drive force decline diagnostic means 8, whereby the screw tightening quality of the electric driver 1 can be confirmed simply and easily, which can contribute to preserving not only the quality of the electric driver 1 but also manufacturing quality in the manufacturing site.

The present working example is designed so that screw type, screw length, and minimum required screw-tightening time are set, but the number of set parameters can be reduced in cases in which a value calculated in advance from the screw type and screw length is set as the minimum required screw-tightening time.

In the present working example, the screw tightening completion determination timeframe is set within the predetermined time range past the minimum required screw-tightening time which is set in advance according to the length of the screw being tightened, but another possible option is to set the screw tightening completion determination timeframe within a predetermined time range after an appropriate time has elapsed past the minimum required screw-tightening time set in advance according to the length of the screw being tightened, in which case the degree of freedom in setting the screw tightening completion determination timeframe can be improved.

In the present working example, the screw tightening diagnostic device 13 is in the form of software included in the electric driver 1, but another possible option is to provide the function of the screw tightening diagnostic device 13 to the management device 9, in which case the electric driver 1 can be provided with the rotational torque sensor 21 and the pressure force sensor 22 alone to make the configuration of the electric driver 1 less expensive.

The screw tightening diagnostic device 13 of the present working example can also be applied to an impact voltage driver, and the specific configurations of the constituent elements can be appropriately designed.

1. A screw tightening diagnostic device for performing a diagnosis on a tightened state of a screw when a screw has been tightened using an electric driver, the screw tightening diagnostic device comprising rotational torque detection means for detecting that rotational torque occurring in a rotating shaft of the electric driver has reached a preset rotational torque within a predetermined time range past a minimum required screw-tightening time that has been set in advance according to a length of the screw being tightened, pressure force detection means for detecting that pressure force created by the electric driver pressing the screw when the screw is being tightened has reached a preset pressure force, and screw tightening diagnostic means for diagnosing that screw tightening has been performed in a normal manner when the rotational torque detection means detects that the preset rotational torque has been reached within the predetermined time range past the minimum required time and the pressure force detection means has detected the preset pressure force.

2. The screw tightening diagnostic device according to claim 1, wherein the screw tightening diagnostic means is configured so as to diagnose that screw tightening has been performed properly when the rotational torque detection means has detected that the preset rotational torque has been reached within the predetermined time range past the minimum required time and the pressure force detection means has detected the preset pressure force.

3. The screw tightening diagnostic device according to claim 1, wherein the pressure force detection means is composed of a pressure force sensor for sensing the pressure force occurring due to the electric driver pressing the screw, and a pressure force identification unit for identifying that the pressure force sensed by the pressure force sensor has reached a preset pressure force.

4. The screw tightening diagnostic device according to claim 2, wherein the pressure force detection means comprises a pressure force sensor for sensing the pressure force occurring due to the electric driver pressing the screw, and a pressure force identification unit for detecting that the pressure force sensed by the pressure force sensor has reached a preset pressure force.

5. The screw tightening diagnostic device according to claim 3 comprising the electric driver, the electric driver being provided with the pressure force sensor.

6. The screw tightening diagnostic device according to claim 4 comprising the electric driver, the electric driver being provided with the pressure force sensor.

7. The screw tightening diagnostic device according to claim 1, wherein the rotational torque detection means comprises a rotational torque sensor for sensing the rotational torque occurring due to the screw being turned by the electric driver, the screw tightening diagnostic device comprising the electric driver, and the electric driver being provided with the rotational torque sensor.

8. The screw tightening diagnostic device according to claim 2, wherein the rotational torque detection means comprises a rotational torque sensor for sensing the rotational torque occurring due to the screw being turned by the electric driver, the screw tightening diagnostic device comprising the electric driver, and the electric driver being provided with the rotational torque sensor.

9. The screw tightening diagnostic device according to claim 5, wherein the rotational torque detection means comprises a rotational torque sensor for sensing the rotational torque occurring due to the screw being turned by the electric driver, the screw tightening diagnostic device comprising the electric driver, and the electric driver being provided with the rotational torque sensor.

10. The screw tightening diagnostic device according to claim 6, wherein the rotational torque detection means comprises a rotational torque sensor for sensing the rotational torque occurring due to the screw being turned by the electric driver, the screw tightening diagnostic device comprising the electric driver, and the electric driver being provided with the rotational torque sensor.

11. The screw tightening diagnostic device according to claim 1, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

12. The screw tightening diagnostic device according to claim 2, comprising a setting unit for setting the minimum required screw-tightening time, the predetermined time range, and the rotational torque, which are set in advance in the rotational torque detection means, as well as the pressure force set in advance in the pressure force detection means; and also a notification unit for issuing a notification of a result of a screw tightening diagnosis made by the screw tightening diagnostic means.

13. The screw tightening diagnostic device according to claim 5, comprising a setting unit for setting the minimum required screw-tightening time, the predetermined time range, and the rotational torque, which are set in advance in the rotational torque detection means, as well as the pressure force set in advance in the pressure force detection means; and also a notification unit for issuing a notification of a result of a screw tightening diagnosis made by the screw tightening diagnostic means.

14. The screw tightening diagnostic device according to claim 6, comprising a setting unit for setting the minimum required screw-tightening time, the predetermined time range, and the rotational torque, which are set in advance in the rotational torque detection means, as well as the pressure force set in advance in the pressure force detection means; and also a notification unit for issuing a notification of a result of a screw tightening diagnosis made by the screw tightening diagnostic means.

15. The screw tightening diagnostic device according to claim 7, comprising a setting unit for setting the minimum required screw-tightening time, the predetermined time range, and the rotational torque, which are set in advance in the rotational torque detection means, as well as the pressure force set in advance in the pressure force detection means; and also a notification unit for issuing a notification of a result of a screw tightening diagnosis made by the screw tightening diagnostic means.

16. The screw tightening diagnostic device according to claim 8, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

17. The screw tightening diagnostic device according to claim 9, comprising a setting unit for setting the minimum required screw-tightening time, the predetermined time range, and the rotational torque which are set in advance in the rotational torque detection means, as well as the pressure force set in advance in the pressure force detection means; and also a notification unit for issuing a notification of a result of a screw tightening diagnosis made by the screw tightening diagnostic means.

18. The screw tightening diagnostic device according to claim 10, comprising a setting unit for setting the minimum required screw-tightening time, the predetermined time range, and the rotational torque, which are set in advance in the rotational torque detection means, as well as the pressure force set in advance in the pressure force detection means; and also a notification unit for issuing a notification of a result of a screw tightening diagnosis made by the screw tightening diagnostic means.

19. An electric driver comprising the screw tightening diagnostic device according to claim 1.

20. The electric driver according to claim 19, comprising drive current detection means for detecting a drive current for driving an electric motor of the electric driver and a rate of drive rotation of the electric motor, and further comprising drive force decline diagnostic means for calculating a drive torque of the electric motor from the drive current and rate of drive rotation detected by the drive current detection means, sensing the rotational torque of the rotating shaft of the electric driver via the rotational torque sensor provided to the rotational torque detection means, and comparing the calculated drive torque with the rotational torque sensed via the rotational torque sensor to diagnose a decline in a drive force of the electric driver.

21. The electric driver according to claim 19, wherein the electric driver has a clutch for cutting off transmission of the rotational torque of the electric driver when the rotational torque occurring in the rotating shaft of the electric driver has reached a preset cutoff rotational torque, the clutch is provided with a cutoff torque adjustment mechanism for variably setting the cutoff rotational torque, and the screw tightening diagnostic device comprises a setting unit that can set the cutoff rotational torque of the cutoff torque adjustment mechanism via remote operation.

22. The electric driver according to claim 20, wherein the electric driver has a clutch for cutting off transmission of the rotational torque of the electric driver when the rotational torque occurring in the rotating shaft of the electric driver has reached a preset cutoff rotational torque, the clutch is provided with a cutoff torque adjustment mechanism for variably setting the cutoff rotational torque, and the screw tightening diagnostic device comprises a setting unit that can set the cutoff rotational torque of the cutoff torque adjustment mechanism via remote operation.
